(19) United States
(12) Patent Application Publication
(10) Pub. No.: US 2001/0014298 A1
(43) Pub. Date: Aug. 16, 2001

(54) Exhaust-gas cleaning installation and process for the catalytic reduction of the level of pollutant in exhaust gas from a combustion system

(76) Inventor: Ronald Neufert, Michelau (DE)

Correspondence Address: LERNER AND GREENBERG, P.A., Post Office Box 2480, Hollywood, FL, 33022-2480, US

(21) Appl. No.: 09/814,488

(22) Filed: Mar. 21, 2001

Related U.S. Application Data
(63) Continuation of application No. PCT/DE99/03008, filed on Sep. 21, 1999.

(30) Foreign Application Priority Data
Sep. 21, 1998 (DE) 198 43 136.8

(51) Int. Cl. F01N 9/00; F01N 3/20; B01D 53/90

(52) U.S. Cl. 422/177; 422/172

(57) ABSTRACT

An exhaust-gas cleaning installation and a process for the catalytic reduction of a pollutant level in exhaust gas from a combustion system are provided for solving the problem of exact metering of reagent in regulated diesel catalytic converters. The metering of the reagent is linked to operationally relevant parameters of the combustion system through the use of a functional relationship and the functional relationship is corrected through the use of pollutant measurement. The pollutant measurement and, if appropriate, the correction, are carried out by an exhaust-gas testing installation which does not form part of the exhaust-gas cleaning installation.

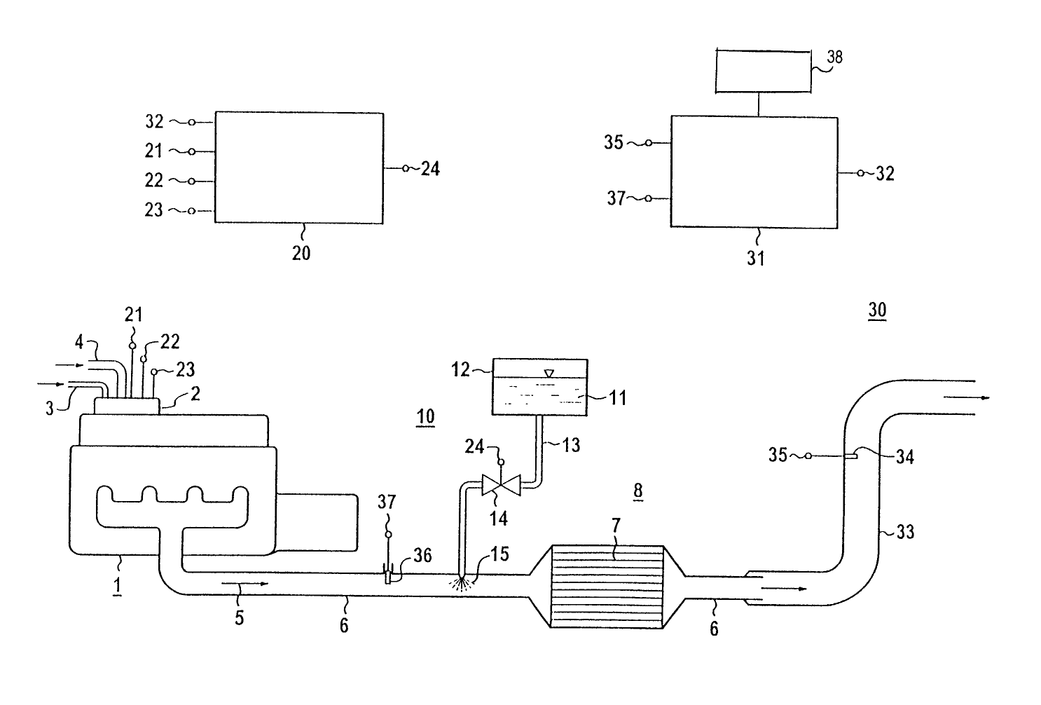

### CROSS-REFERENCE TO RELATED APPLICATION

This application is a continuation of copending International Application No. PCT/DE99/03008, filed Sep. 21, 1999, which designated the United States.

### BACKGROUND OF THE INVENTION

1. Field of the Invention

The invention relates to an exhaust-gas cleaning installation for a combustion system, having a catalytic converter through which the exhaust gas can flow, a metering device for introducing a reagent into the exhaust gas and a monitoring unit which is connected to the metering device. The monitoring unit is constructed for calculating a quantity of pollutant emitted from the combustion system per unit time from operationally relevant parameters of the combustion system using a functional relationship. The invention also relates to a process for catalytically reducing the level of pollutant in the exhaust gas from a combustion system, in which a reagent is added to the exhaust gas and is reacted with the pollutant at a catalytic converter. The quantity of pollutant emitted from the combustion system per unit time is calculated from operationally relevant parameters of the combustion system using a functional relationship and an added quantity of the reagent is calculated therefrom by a monitoring unit. The functional relationship is checked and, if necessary, corrected. A device of that type and a process of that type are known, for example, from U.S. Pat. No. 5,628,186.

The term “functional relationship” is understood as meaning a mathematical function which assigns a value to a state that is determined by one or more variables. The functional relationship may, in particular, be in the form of a characteristic curve or a multi-dimensional characteristic diagram.

The use of fossil fuels in a combustion system, in particular in an internal-combustion engine for driving a motor vehicle, provides considerable problems due to the pollutant level in the exhaust gas, particularly in industrialized countries.

In order to reduce the levels of pollutants in the exhaust gas from a spark-ignition engine, various catalytic converters are known which contain precious metals and at which hydrocarbons and carbon monoxide are converted, together with nitrogen oxides and residual oxygen, to form carbon dioxide, nitrogen and water. In order to reduce the pollutant emission from a diesel engine, there is currently widespread work ongoing on the development of a regulated diesel catalytic converter. It should be possible with that device to considerably lower the level of nitrogen oxides in the exhaust gas from a diesel engine. It is preferable to use a so-called deNOx catalytic converter which reacts the nitrogen oxides contained in the exhaust gas with a suitable reagent, generally ammonia, using the selective catalytic reduction (SCR) process, to form environmentally friendly nitrogen and water. In that process, the reagent or a precursor of the reagent is introduced into the exhaust gas upstream of the catalytic converter, as seen in the direction of flow of the exhaust gas, and then enters the catalytic converter preferably in a homogeneous mixture with the nitrogen oxides contained in the exhaust gas.

A combustion system for driving a vehicle is operated with a variable load and rotational speed. This means that the quantities of nitrogen oxides generated per unit time and the exhaust-gas mass flow rate and temperatures are subject to considerable fluctuations. Currently, there is no known solution for setting the quantity of reagent which is to be introduced into the exhaust gas per unit time in such a manner that high separation rates for the nitrogen oxides are achieved irrespective of the operating state of the internal-combustion engine, combined with a simultaneously minute emission of the reagent into the environment. An additional difficulty is that a reagent such as ammonia is toxic and causes considerable odor pollution to people even at concentrations of only a few ppm. For that reason, the emission of ammonia into the environment, known as reagent slippage, is to be avoided at all costs.

U.S. Pat. No. 5,628,186 and German Published, Non-Prosecuted Patent Application DE 195 36 571 A1 have disclosed a device and a process in which the quantity of reagent introduced into the exhaust gas per unit time is set as a function of operationally relevant parameters of the engine, the catalytic converter and the exhaust gas. A functional relationship is stored in a monitoring unit, in the form of a characteristic diagram, with the aid of which the emission of nitrogen oxides from the engine and the quantity of reagent which is to be injected per unit time is calculated from the operationally relevant parameters. The characteristic diagram is corrected during operation in order to take into account changes in the quantity of nitrogen oxides which is actually produced by the engine, for example due to aging phenomena or other long-term effects, in the calculations of the quantity of nitrogen oxides. In order to do that, under suitable conditions a sensor measures the pollutant concentration in the exhaust gas from the internal-combustion engine and compares the measured value with the value which has been calculated from the operationally relevant parameters through the use of the characteristic diagram. In the event of the calculated value deviating from the measured value by more than a tolerance limit, the characteristic diagram is corrected.

Carrying out a process of that type in order to adapt the metering of reagent, for example to aging phenomena of the combustion system, requires the quantity of nitrogen oxides in the exhaust gas to be measured. Since currently there are no sensors which are sensitive to nitrogen oxide and react rapidly enough to supply reliable measured values in the event of rapidly changing operating conditions, a process as described in particular in German Published, Non-Prosecuted Patent Application DE 195 36 571 A1 is difficult to carry out, which represents a drawback.

### SUMMARY OF THE INVENTION

It is accordingly an object of the invention to provide an exhaust-gas cleaning installation for a combustion system and a process for the catalytic reduction of the level of pollutant in exhaust gas from a combustion system, which overcome the hereinafore-mentioned disadvantages of the heretofore-known devices and processes of this general type and with which metering of a reagent can easily be adapted to changed conditions caused by aging phenomena or wear to the combustion system.

With the foregoing and other objects in view there is provided, in accordance with the invention, an exhaust-gas cleaning installation, comprising a catalytic converter through which the exhaust gas can flow, a metering device for introducing a reagent into the exhaust gas and a monitoring unit which is connected to the metering device. The monitoring unit is constructed to calculate the quantity of pollutant emitted from the combustion system per unit time from operationally relevant parameters of the combustion system, through the use of a functional relationship. According to the invention, the monitoring unit has an interface which is adapted to transfer data with an external measuring appliance or an external control unit.

The functional relationship has to be checked in order to adapt the metering of reagent to changed conditions caused by aging phenomena or wear to the combustion system. This takes place by measuring the quantity of pollutant in the exhaust gas and comparing the measured value with the value calculated from the functional relationship. If the calculated value lies outside a tolerance range around the measured value, the functional relationship is corrected on the basis of a correction program.

In a first step, the invention is based on the consideration that the currently available sensors which are sensitive to nitrogen oxides are sensors which have to accumulate measured data over a prolonged measurement period, in order to generate a reliable measured value. These sensors need operating conditions which remain constant over a prolonged period in order to carry out measurements which give reliable results. These operating conditions cannot be reached in normal operation of the combustion system. The operating conditions of the internal-combustion engine are generally subject to considerable fluctuations, particularly in a motor vehicle. Therefore, nitrogen oxide measurements which are to supply measured values that can be reliably used to reach decisions can only be achieved when the combustion system is operated in a manner that is specifically tailored to the sensor in question.

In a second step, the invention is based on the consideration that the test operation of the combustion system which is required in order to measure nitrogen oxides needs to be carried out by specialist personnel, due to the operating conditions which are to be maintained. Specifically, when checking the nitrogen oxide emissions from an internal-combustion engine of a motor vehicle, it cannot be assumed that the owner of the motor vehicle is readily able to carry out the test operation. In order to ensure that checking the nitrogen oxide measurement does not involve an unreasonable additional outlay for the operator of the combustion system, it is expedient for checks of this type to be combined with carrying out maintenance work on the combustion system or, specifically in the case of motor vehicle engines, with carrying out statutory special exhaust-gas tests.

In a third step, the invention is based on the consideration that a nitrogen oxide measurement to be carried out by specialist personnel is not sensibly carried out by using a sensor which belongs to the metering device of the exhaust-gas cleaning system, but rather by an external sensor, i.e. a sensor which does not belong to the metering device. This may, for example, be a sensor of an exhaust-gas testing installation in a workshop, which is operated by specialist personnel. In an exhaust-gas testing installation, an easy-to-use, reliable and therefore expensive sensor can be used at significantly lower cost than would be possible if the sensor were fixedly installed in the exhaust-gas cleaning installation. In order to correct the functional relationship through the use of nitrogen oxide measurements which are carried out by an exhaust-gas testing installation, it is necessary to exchange data between the monitoring unit of the exhaust-gas cleaning installation and the exhaust-gas testing installation. In order to allow data exchange of this type, it is appropriate to equip the monitoring unit with an interface to which the measuring appliance or the control unit of the exhaust-gas testing installation can be connected.

An exhaust-gas cleaning installation, having a monitoring unit which can be connected to an exhaust-gas testing installation, does not require a dedicated sensor for measuring the pollutant emission from the combustion system in order to check the functional relationship. This represents a cost advantage in particular when retrofitting the combustion system with an exhaust-gas cleaning installation, since not only the sensor per se but also the installation of the sensor in the exhaust pipe of the combustion system are dispensed with. Since the functional relationship can be checked and corrected by the exhaust-gas testing installation, with a monitoring unit of this type in the exhaust-gas cleaning installation, it is also possible to dispense with a dedicated program to correct the functional relationship. This simplifies the monitoring unit and has a beneficial effect on the production costs of the monitoring unit.

In accordance with another feature of the invention, the interface of the monitoring unit is constructed as a plug or screw connection. This allows simple manual connection of the monitoring unit to a measuring appliance or a control unit of an exhaust-gas testing installation. The interface can be disposed in such a way that it is easily accessible on the monitoring unit, so that a plug connector can readily be connected by hand.

The fact that data can be transmitted from the monitoring unit, through the interface, to an external measuring appliance or to an external control unit, allows the functional relationship which is stored in the monitoring unit to be transmitted, in the form of data, to the exhaust-gas testing installation, which uses measured values to check and, if appropriate, correct it. The functional relationship is then transmitted back to the monitoring unit. A monitoring unit which is constructed in this way does not have to be able to check and correct the functional relationship on its own. This considerably simplifies the structure of the monitoring unit.

The monitoring unit is expediently constructed in such a manner that the instantaneously present values of the operationally relevant parameters of the combustion system and if appropriate the exhaust gas as well can be transmitted as data by the interface. These values are required in order for the exhaust-gas testing installation to check the functional relationship. The values are available to the monitoring unit at any time during operation of the exhaust-gas cleaning installation. In this way they can be made available to the exhaust-gas testing installation without major outlay, so that the exhaust-gas testing installation does not then have to separately determine the values.

In accordance with a further feature of the invention, the monitoring unit is constructed to correct the functional relationship. In this configuration of the invention, the monitoring unit is constructed to receive the pollutant measured values from the exhaust-gas testing installation and also to check the functional relationship on the basis of these measured values. This configuration has the advantage of not requiring the functional relationship to be transmitted to the exhaust-gas testing installation in order to be checked and corrected, but rather it can be corrected by the monitoring unit immediately after transmission of the measured values.

In accordance with an added feature of the invention, the monitoring unit is constructed to correct the functional relationship on the basis of measured values at individual points of the operationally relevant parameters over the entire range of parameter values or a partial range thereof. A monitoring unit constructed in this manner is able to correct the functional relationship without measurements of the pollutant emission from the combustion system having to be present over an entire range of parameter values for this purpose.

With the objects of the invention in view, there is also provided, a process for catalytically reducing a pollutant level in exhaust gas from a combustion system, which comprises adding a reagent to the exhaust gas and reacting the reagent with a pollutant at a catalytic converter. The quantity of pollutant emitted from the combustion system per unit time is calculated from operationally relevant parameters of the combustion system through the use of a functional relationship, an added quantity of reagent is calculated from this by a monitoring unit, and the functional relationship is checked and, if necessary, corrected. According to the invention, the quantity of pollutant is measured by using an external measuring appliance and the check is carried out on the basis of the measured values. The checking and, if appropriate, the correction of the functional relationship is carried out in conjunction with maintenance work on the combustion system. In the case of an internal-combustion engine in a motor vehicle this may, for example, be carried out in conjunction with a statutory special exhaust-gas test, a main examination or a routine inspection. This procedure represents a minimum outlay for the owner of the motor vehicle.

In order to adapt the reagent metering to changed operating conditions such as, for example, aging phenomena or wear to the combustion system, it is necessary to measure the quantity of pollutant emitted from the combustion system as a function of the values of the operationally relevant parameters. Execution of these measurements requires operating conditions which are adapted to the measuring appliance and should therefore be supervised by an appliance which is specifically constructed for this purpose. The measuring appliance and the supervisory appliance expediently form a single unit. Since there is a high level of complexity involved with equipping every exhaust-gas cleaning installation with a measuring and supervision appliance of this type, it is expedient for the pollutant measurement to be carried out by using an external measuring appliance, i.e. a measuring appliance which does not form part of the exhaust-gas cleaning installation. The measuring appliance and supervisory appliance are, for example, parts of an exhaust-gas testing installation.

For economic reasons, a measuring appliance which is fixedly installed with respect to an exhaust-gas cleaning installation cannot be as conveniently and reliably constructed as is possible with a measuring appliance associated with the exhaust-gas testing installation. Therefore, the measurement of the pollutant emission from a combustion system can be carried out particularly easily by using an external measuring appliance.

The checking and, if appropriate, correction of the functional relationship is also carried out in a simple manner by an external appliance, for example an exhaust-gas testing installation. An installation of this type has a significantly more convenient and precise program for checking and correcting the functional relationship than is the case with an exhaust-gas cleaning installation, for economic reasons. It is also significantly easier and less expensive to update a single correction program associated with an exhaust-gas testing installation than to update the program of every exhaust-gas cleaning installation. Therefore, an exhaust-gas testing installation can have the most modern engineering at relatively low cost.

In accordance with another mode of the invention, the checking and correction of the functional relationship is carried out by the monitoring unit itself. This process has the advantage of simplifying the data transfer between the monitoring unit of the exhaust-gas cleaning installation and the exhaust-gas testing installation. Furthermore, the process offers the advantage of not requiring the exhaust-gas testing installation to be constructed for the correction of a multiplicity of different functional relationships associated with different combustion systems.

In accordance with a further mode of the invention, the functional relationship is corrected on the basis of measured values at individual points of the operationally relevant parameters over the entire parameter value range or a partial range thereof. This process has the advantage of not requiring the pollutant emission from the combustion system to be measured over the entire range of values of each operationally relevant parameter, to check the functional relationship. Rather, it is sufficient to measure the pollutant emission at a number of selected parameter values. The correction may, for example, be carried out by interpolation or by a correction algorithm which is specifically tailored to the combustion system.

In accordance with an added mode of the invention, the monitoring unit transmits suitable values of the operationally relevant parameters to the external measuring appliance or an external control appliance for the purpose of checking the functional relationship. By way of example, values at which the calculated pollutant emission is subject to considerable fluctuations with small changes in the parameters are suitable. Furthermore, those values at which the calculated pollutant emission forms a local maximum in the event of variation of a parameter are also suitable. The measurement of the pollutant emission at these values determined by the monitoring unit considerably simplifies the execution of the correction mechanism of the functional relationship.

In accordance with an additional mode of the invention, the pollutant measurement is carried out in the exhaust-gas stream upstream of the catalytic converter. In this region between the combustion system and the catalytic converter, the pollutant content in the exhaust gas is measured directly.

In accordance with yet another mode of the invention, the pollutant measurement is carried out in the exhaust-gas stream downstream of the catalytic converter and the activity of the catalytic converter is determined. If, at the same time, a pollutant measurement is carried out upstream of the catalytic converter, the activity of the catalytic converter can easily be determined from the two measurements. If there is no pollutant measurement carried out upstream of the catalytic converter, the activity of the catalytic converter can be determined from the pollutant emission from the combustion system which is calculated through the use of the functional relationship and from the quantity of pollutant which is measured in the exhaust gas downstream of the catalytic converter. The activity of the catalytic converter can be taken into account when calculating the quantity of reagent to be added to the exhaust gas during normal operation of the exhaust-gas cleaning installation. This takes place as a result of the activity being included as a parameter in the correction of the functional relationship. This means that, during operation of the exhaust-gas cleaning installation, in the event of a reduced activity of the catalytic converter, by way of example a smaller added quantity of reagent is introduced into the exhaust gas.

In accordance with a concomitant mode of the invention, in the event of the activity of the catalytic converter falling below a fixed level, a signal is expediently emitted to a display device. In this way, for example, a defect or the unsuitability of the catalytic converter due to aging phenomena is signaled. In this way, attention is drawn to the fact that the catalytic converter has to be exchanged.

Other features which are considered as characteristic for the invention are set forth in the appended claims.

Although the invention is illustrated and described herein as embodied in an exhaust-gas cleaning installation and a process for the catalytic reduction of the level of pollutant in exhaust gas from a combustion system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The FIGURE of the drawing is a diagrammatic and schematic illustration of an embodiment of the invention.

### DESCRIPTION OF THE PREFERRED EMBODIMENTS

Referring now in detail to the single FIGURE of the drawing, there is seen a combustion system 1 having an exhaust-gas cleaning installation 8 and an exhaust-gas testing installation 30 which is connected thereto. The combustion system 1 is a diesel engine for driving a motor vehicle. The diesel engine has an interface 2, at which current values of operationally relevant parameters can be tapped. A fuel/air mixture is made available to the diesel engine for combustion through a fuel feed 3 and an air feed 4. Exhaust gas 5 from the diesel engine is passed through a manifold into an exhaust pipe 6 and onward through a catalytic converter 7. The catalytic converter 7 is constructed as a so-called deNOx catalytic converter which, with the aid of the reagent ammonia, uses the known SCR process to convert nitrogen oxides into molecular nitrogen and water. The quantity of ammonia which is required is obtained from metered urea by hydrolysis.

The catalytic converter 7 forms part of an exhaust-gas cleaning installation 8 which, in addition to the catalytic converter 7, also includes a metering device 10 and a monitoring unit 20. The metering device 10 is provided for metering a reagent (urea) 11 and includes a tank 12 holding urea, a feed line 13, a metering valve 14 and an injection nozzle 15.

The metering device 10 is controlled by the monitoring unit 20. Current values for rotational speed, position of an accelerator pedal and engine temperature are available to the monitoring unit 20 as operationally relevant parameters, over connections 21, 22 and 23 between the interface 2 of the diesel engine and the monitoring unit 20. The monitoring unit 20 uses a functional relationship, which is stored in the monitoring unit 20 in the form of a multidimensional characteristic diagram, in order to calculate from these values a quantity of pollutant which is emitted from the diesel engine per unit time. The monitoring unit 20 is connected to the metering valve 14 of the metering device 10 through an interface 24. A quantity of reagent 11 which has been calculated from the operationally relevant parameters is added per unit time through the injection nozzle 15 to the exhaust gas 5.

The monitoring unit 20 is connected to a control unit 31 of the exhaust-gas testing installation 30 through an interface 32. The interface 32 is constructed as a male plug connector, onto which a corresponding female plug connector of a connecting cable between the monitoring unit 20 and the control unit 32 can easily be fitted.

The exhaust-gas testing installation 30 includes the control unit 31, an exhaust-gas connection piece 33 and pollutant sensors 34, 36 which are connected to the control unit 31 by interfaces 35 and 37. The pollutant sensors 34, 36 measure nitrogen oxide concentration through the use of a change in conductivity and are disposed in the exhaust gas upstream and downstream of the catalytic converter 7.

The pollutant sensor 36 measures the quantity of nitrogen oxides in the exhaust gas 5 from the engine and is introduced into the exhaust pipe 6 at a point which is provided for this purpose.

The pollutant sensor 34 is connected to the exhaust-gas connection piece 33 of the exhaust-gas testing installation 30.

In order to check the characteristic diagram, a connection is produced between the monitoring unit 20 of the exhaust-gas cleaning installation 8 and the control unit 31 of the exhaust-gas testing installation 30, through the interface 32. This takes place as part of maintenance, inspection or repair work which is to be carried out on the engine or the vehicle or as part of statutory special exhaust-gas tests. The monitoring unit 20 then calculates suitable parameter values for the operationally relevant parameters, at which the characteristic diagram is to be checked, from the stored characteristic diagram. These values are then transmitted to the control unit 31 of the exhaust-gas testing installation 30. Furthermore, the current values of the operationally relevant parameters are transmitted from the monitoring unit 20 to the control unit 31. The control unit 31 checks whether or not one of the suitable values is present and whether or not suitable operating conditions are prevailing for pollutant measurement. In order to produce these operating conditions, the values of the operationally relevant parameters are displayed, for example on a display device 38 associated with the exhaust-gas testing installation 30. The operationally relevant parameters can be set manually. Under suitable operating conditions, one or more pollutant measurements are carried out by the sensor 36, which is disposed upstream of the catalytic converter 7, as seen in the direction of flow of the exhaust gas. The nitrogen oxide emission determined from the measurements and the associated values of the operationally relevant parameters are then transmitted from the control unit 31 to the monitoring unit 20.

The monitoring unit 20, which is constructed to check and correct the characteristic diagram, checks the characteristic diagram on the basis of the values transmitted from the control unit 31. For this purpose, the pollutant emission from the combustion system 1, that is associated with the values of the operationally relevant parameters which are transmitted from the control unit 31, is calculated and is compared with the measured values. If a calculated value lies more than a tolerance away from the relevant value determined by measurements, the multidimensional characteristic diagram is corrected, in accordance with the value determined by measurement, in a partial range around the value. In this way, the characteristic diagram is corrected on the basis of individual pollutant values obtained by measurement over the entire parameter value range of the characteristic diagram or a partial range thereof.

In an alternative process, the characteristic diagram is checked by the control unit 31 of the exhaust-gas testing installation 30 and is corrected if necessary. In order to do this, in addition to the data concerning the operationally relevant parameters, the characteristic diagram is transmitted from the monitoring unit 20 to the control unit 31.

In a further step of the process, pollutant measurements are carried out upstream and downstream of the catalytic converter 7, as seen in the direction of flow of the exhaust gas, with the aid of the two pollutant sensors 36 and 34. The activity of the catalytic converter 7 is determined from the measured values. If the activity falls below a fixed value, a signal is emitted from the control unit 31 of the exhaust-gas testing installation 30 to a display device 38 which is provided for this purpose. In this way, it is indicated that the catalytic converter 7 is defective or has to be exchanged due to aging-related wear.

I claim:

1. An exhaust-gas cleaning installation for a combustion system, comprising:
a catalytic converter through which exhaust gas from a combustion system can flow;
a metering device for introducing a reagent into the exhaust gas; and
a monitoring unit connected to said metering device for calculating a quantity of pollutant emitted from the combustion system per unit time from operationally relevant parameters of the combustion system using a functional relationship;
said monitoring unit having an interface to be connected to an external measuring or control unit for transmitting at least one of the functional relationship and values for the operationally relevant parameters in the form of data through said interface between said monitoring unit and the external measuring or control unit, for checking and, if appropriate, correcting the functional relationship with the external measuring or control unit.

2. The exhaust-gas cleaning installation according to claim 1, wherein said interface is a plug connection.

3. The exhaust-gas cleaning installation according to claim 1, wherein said interface is a screw connection.

4. The exhaust-gas cleaning installation according to claim 1, wherein said monitoring unit corrects the functional relationship.

5. The exhaust-gas cleaning installation according to claim 1, wherein said monitoring unit corrects the functional relationship on the basis of individual measured points over at least a partial range of parameter values.

6. A process for catalytically reducing a pollutant level in exhaust gas from a combustion system, which comprises:
adding a reagent to exhaust gas from a combustion system and reacting the reagent with a pollutant at a catalytic converter;
calculating a quantity of the pollutant emitted from the combustion system per unit time from operationally relevant parameters of the combustion system using a functional relationship and calculating an added quantity of the reagent therefrom with a monitoring unit;
measuring the quantity of pollutant with an external measuring or control unit supplying measured values; and
checking and, if appropriate, correcting the functional relationship on the basis of the measured values from the external measuring or control unit, in conjunction with maintenance work on the combustion system.

7. The process according to claim 6, which further comprises carrying out the step of correcting the functional relationship with the monitoring unit.

8. The process according to claim 6, which further comprises carrying out the step of correcting the functional relationship on the basis of individual measured points over at least a partial range of values of the operationally relevant parameters.

9. The process according to claim 6, which further comprises transmitting suitable values of the operationally relevant parameters from the monitoring unit to the external measuring or control unit for checking the functional relationship.

10. The process according to claim 6, which further comprises measuring the pollutant in an exhaust-gas stream upstream of the catalytic converter.

11. The process according to claim 10, which further comprises performing a pollutant measurement in the exhaust-gas stream downstream of the catalytic converter and determining activity of the catalytic converter.

12. The process according to claim 6, which further comprises performing a pollutant measurement in an exhaust-gas stream downstream of the catalytic converter and determining activity of the catalytic converter.

13. The process according to claim 11, which further comprises emitting a signal to a display device if the activity falls below a fixed value.

14. The process according to claim 12, which further comprises emitting a signal to a display device if the activity falls below a fixed value.
